(19) United States
(12) Patent Application Publication
(10) Pub. No.: US 2007/0067148 A1
(43) Pub. Date: Mar. 22, 2007

(54) Computer system for determining a drug dosage

(76) Inventors: Peter Fritzson, Linkoping (SE); Lars Baltzer, Uppsala (SE)

Correspondence Address: HAYES, SOLOWAY P.C., 3450 E. SUNRISE DRIVE, SUITE 140, TUCSON, AZ, 85718, US

(21) Appl. No.: 10/595,491

(22) PCT Filed: Oct. 21, 2004
(86) PCT No.: PCT/SE04/01524

§ 371 Date: Jul. 17, 2006

(30) Foreign Application Priority Data
Oct. 24, 2003 (SE) 0302815-6

(51) Int. Cl. G06G 7/48

(52) U.S. Cl. 703/11

(57) ABSTRACT

An apparatus for determining a drug dosage is disclosed comprising: an input interface for receiving data on at least one patient's biochemical profile, and data on at least one specific property of the drug; and processing means having a simulation module for simulating the effect of a certain dosage based on the received data, and an evaluation module for determining, based on a simulation on at least one dosage, a drug dosage for the at least one patient in question. A corresponding method is also disclosed. Hereby, a dosage may be personalized on the basis of the condition and state of each patient, leading to a more effective dosage. This leads to a better and less hazardous treatment of the patient, as well as decreased health related costs in the society. Further, the strain on the environment could be reduced.

### FIELD OF THE INVENTION

The present invention relates to a computer system for determining a drug dosage, an automatic dosage device, and a computer-implemented method for determining a drug dosage. It further relates to a corresponding computer program.

### BACKGROUND OF THE INVENTION

Many patients get non-optimal treatment using drugs. It is quite common that part of the population gets a non-optimal dosage causing adverse side-effects. In a number of cases the side-effects might even be worse than the problem the patient is asking for a cure to. In fact, it is estimated that only approximately 20% of the patients get the correct dosage.

Drug dosage is usually optimized for, and adapted to, average adult white male persons. People who do not belong to that group, e.g. females, children, certain minority groups of people, very often get problems from drugs due to incorrect dosage.

Although there are usually different dosage recommendations for children, and sometimes for females, the dosage is still incorrect in many cases. In fact, there exist a vast number of parameters influencing the decomposition and ingestion of a medical substance in a patient's body, as well as the reactions caused by the substances. At present though, the only personalization factors that may influence the dosage are whether you are a child or not, and sometimes your sex or weight.

Additionally, incorrect dosage usually leads to over-consumption of drugs. The prescription from the doctor is often too much, to be on the “safe” side. This leads to increased costs for society and increased environmental pollution from chemical substances, not to mention the often hazardous treatment the patient has to endure, with possible side-effects and the like.

In order to avoid over-consumption of drugs, as well as side-effects caused by incorrect dosages, it would be very advantageous if it was possible to adapt drug dosage individually. However, due to the enormous complexity of biological systems, and the difficulty in predicting cellular and subcellular processes, it has not yet been possible to develop concepts for personalised drug dosage.

WO 02/44992 describes a computerized system for modelling biological pathways. The system comprises a web-based user interface, a database for knowledge storage, and computerized systems and machine learning tools for data analysis, simulation and dynamic graphical representation of the pathways. The aim of WO 02/44992 is to provide a system for modelling biological pathways and ascertaining their effect on intercellular systems, e.g. in order to increase the understanding of disease processes. Accordingly, the focus of WO 02/44992 is on developing and storing the equations, in order to be able to observe, prepare and study models of biological pathways.

There are also open publications earlier than that patent application, describing similar approaches, e.g. Hakman, Mikael, and Torgny Groth, “Object-oriented Biomedical System Modelling—The Language”, Computer Methods and Programs in Biomedicine, Volume 60, Issue 3, pp 153-181, November, 1999, and Hakman, Mikael, “Methods and Tools for Object-Oriented Modelling and Knowledge-Based Simulation of Complex Biomedical Systems”, PhD Thesis—Uppsala University, 2000.

### SUMMARY OF THE INVENTION

An object of the present invention is to provide a personalised drug dosage. This object is achieved by a computer system, an automatic dosage device, a method and a computer program as defined in the enclosed claims.

According to a first aspect of the invention, it relates to an apparatus for determining a drug dosage comprising:

an input interface for receiving data on at least one patient's biochemical profile, and data on at least one specific property of the drug;

processing means having a simulation module for simulating the effect of a certain dosage based on the received data, and an evaluation module for determining, based on a simulation on at least one dosage, a drug dosage for the at least one patient in question. Preferably the evaluation is based on simulations on different dosages.

The term “automatic dosage device” as used in this application is to be interpreted broadly. The automatic dosage device may as an output deliver a quantity value representing a certain dosage to be used. Such a quantity value may be delivered by a visual interface, such as a text message on a display, an audio interface, or the like. However, the output from the automatic dosage device may alternatively be an actual dosage of the medication to be used. To this end, the device may comprise a delivery unit adapted to supply an amount of the pharmaceutical preparation corresponding to the determined dosage, subsequently to be given to the patient directly or to be mixed in nourishment to be given to the patient. Alternatively, the delivery unit may be controlled to provide the drug corresponding to the determined dosage directly to the patient, e.g. through injection.

By means of the invention the dosage may be personalized on the basis of the condition and state of each patient, leading to a more effective dosage. This would lead to a better and less hazardous treatment of the patient, as well as decreased health related costs in the society. Further, the strain on the environment would be reduced.

The biochemical profile data may comprise at least one parameter related to the patient's metabolic pathways, and the biochemical profile data is determined based on measurements performed on a blood sample from the patient. Hereby, a very effective, veracious and realistic simulation of a complex biological system could be performed in a relatively simple way. By basing the simulation on only a measurement on a blood sample from the patient, the measurement process becomes very expedient.

The measurement to determine the biochemical profile data may be made using a scaffold technique. This technique has surprisingly been found to be very efficient for acquiring model parameters for the above-discussed simulation process involved in the present invention. (See e.g. Karin Enander, Gunnar Dolphin, Linda Andersson, Bo Liedberg, Ingemar Lundström, Lars Baltzer: “Designed, Folded Polypeptide Scaffolds that Combine key Biosensing Events of Recognition and Reporting”, J. Org. Chem. 2002, 67, 3120-3123.)

The parameters related to a metabolic pathway which may be measured are e.g. the concentration of reactants in the metabolic pathway, the speed of the reaction to which the pathway pertains, and the time required for decomposition of the drug. The specific properties of the drug to be measured are e.g. the distribution rate of the drug and the decomposition time of the active ingredients, as well as the decomposition time of possible by-products. The simulation module may be formed with an equation based modelling programming language, which is further object-oriented. The programming language may further define a multi-domain modelling capability. Such a programming language has shown to be very efficient for forming of the models underlying the simulation. Alternatively, the simulation module can be programmed in any programming language suitable for computation, which need not be object-oriented or multi-domain.

The simulation module may be adapted to perform a metabolic pathway simulation based on the received data.

The input interface receives data specifying the most important metabolic pathways that are involved in the mechanisms of the drug in question, and the simulation module performs simulations primarily involving those specified pathways.

The evaluation module determines a drug dosage based on the relation between desired levels of reactant concentration and drug concentration in the simulated process.

According to another aspect of the invention, it relates to an automatic dosage device comprising a computer system as described above. Such an automatic dosage device may be used to the same end as the computer system discussed above. Further, an automatic dosage device may be used as a stand alone device, making it easier to set-up and use. Further, such devices may e.g. be provided to the user and/or physician together with a drug, whereby the device may be preset with data and a simulation process adapted for said medicine.

The automatic dosage device may further comprise a measurement unit for determining a patients biochemical profile, and the measurement unit may be connected to the input interface of the computer system.

The measurement unit may determine the patient's biochemical profile based on a blood sample or other sample from the patient.

The automatic dosage may further comprise an output unit, such as a display, for communicating a recommended drug dosage for the patient in question to a user.

The automatic dosage device may be arranged within a self-contained portable unit.

According to yet another aspect of the invention it relates to a computer-implemented method for determining a drug dosage comprising:

receiving data regarding at least one patient's biochemical profile relevant to the drug influence;

receiving data regarding at least one specific property of the drug;

simulating the effect of a at least one dosage based on the received data; and

determining a drug dosage for the patient in question based on the outcome of said simulation.

By means of this aspect, similar advantages are obtained as discussed above in relation to the previous aspects. Preferably, the simulation is repeated at least once with another dosage.

The simulation step may be repeated until a predetermined condition is met. Examples of predetermined conditions to be met are: minimising possible side effects, attaining a certain effect, or optimisation to a certain degree. If the effect only sets in at a certain dose concentration, but not below that concentration, that certain dose concentration needs to be maintained for a certain amount of time. Further, concentration might need to be maintained in a certain part of the system, e.g. in one or more specific organs, for a certain period. That is to say, the simulation needs to continue long enough to ensure the distribution and action of the drug in appropriate organs.

In the method according to the invention, the biochemical profile data cornprises at least one parameter related to the patient's metabolic pathways (relevant to the drug), and the biochemical profile data relevant to the condition that is to be treated is determined based on measurements performed on a blood sample from the patient. The simulation performs a metabolic pathway simulation based on the received data.

The drug dosage is determined based on the relation between desired levels of reactant concentration and drug concentration in the simulated process.

The invention also relates to a computer program comprising a computer program code for executing the method described above, as well as to a computer-readable medium having the computer program recorded thereon.

### BRIEF DESCRIPTION OF THE DRAWINGS

For exemplifying purposes, the invention will be described in closer detail in the following with reference to embodiments thereof illustrated in the attached drawings, wherein:

FIG. 1 is a schematic illustration of a metabolic pathway and the differences in internal energies between metabolites and short-lived intermediates;

FIG. 2 is a schematic illustration of an apparatus according to an embodiment of the present invention; and

FIG. 3 is a flow chart of a method according to an embodiment of the present invention.

### DETAILED DESCRIPTION OF THE INVENTION

According to the present invention, the main idea is to give each person a personal dosage based on advanced computer simulation and a precise measured biochemical profile of the patient who is about to receive the treatment. This computed dosage is based on three factors:
Specific properties of the drug.
The patient's biochemical profile is measured, i.e. parameters related to one or several metabolic pathways known to be influenced by the drug, the parameters may be estimated from for instance concentrations of reacting substances that may be measured e.g. using a Polypeptide Scaffold technique applied to a simple blood sample.
Advanced modelling and simulation techniques for computer simulation of pathways and other phenomena that can be influenced by the drug in question.

The combination of metabolic pathway simulation based on experimental parameters from measurement techniques, such as using Polypeptide Scaffolds, is unique. The present inventors surprisingly found that the abovementioned combination, in conjunction with the use of newly developed databases, provide far-reaching possibilities for the determination of a personal drug dosage.

The specific properties of the drug which are used for computing an optimal personalised dosage are e.g. the effect of the drug on metabolic pathways. Such information may be obtained from existing public data bases, from drug manufacturers, or by experimental measurements.

For the computer simulation, e.g. the modelling language Modelica may be used. However, the present invention is not limited to the use of Modelica.

In connection with the present invention, conventional modelling and simulation techniques may be used. The present inventors have also developed their own techniques for modelling and simulation, which will be described below.

The invention may be practiced by any doctor specifying drugs. Furthermore, it is possible that patients themselves could use the invention in order to determine a personalized, optimized dosage.

As used herein, a “drug dosage” is meant a dosage of a drug that will lead to a desired pharmacological and/or therapeutic effect. The desired pharmacological and/or therapeutic effect may be to cure or alleviate a disease or a condition, or to prevent the development of a disease or a condition.

Preferably, the sample used according to the invention for characterizing the biochemical profile of an individual is a blood sample, but also other samples, such as liver samples, muscle samples, biopsy, and saliva samples could be used. Additionally, patient information from a database could be used, or information given by the patient or the doctor.

The patient's biochemical profile may be measured using a scaffold technique, which will be further described below, but also other techniques may be used.

The speed of reactions may be measured by experimental data combined with estimations.

Biochemical Profile

The biochemical profile of an individual can be characterized by a total of 15-16 different pathways. However, the number of pathways which is needed in order to characterize the biochemical profile of an individual varies and may be fewer or more than 15-16.

Each pathway is a chain of reactions, where the properties of each reaction can differ somewhat between different persons depending on the concentration of enzymes, etc.

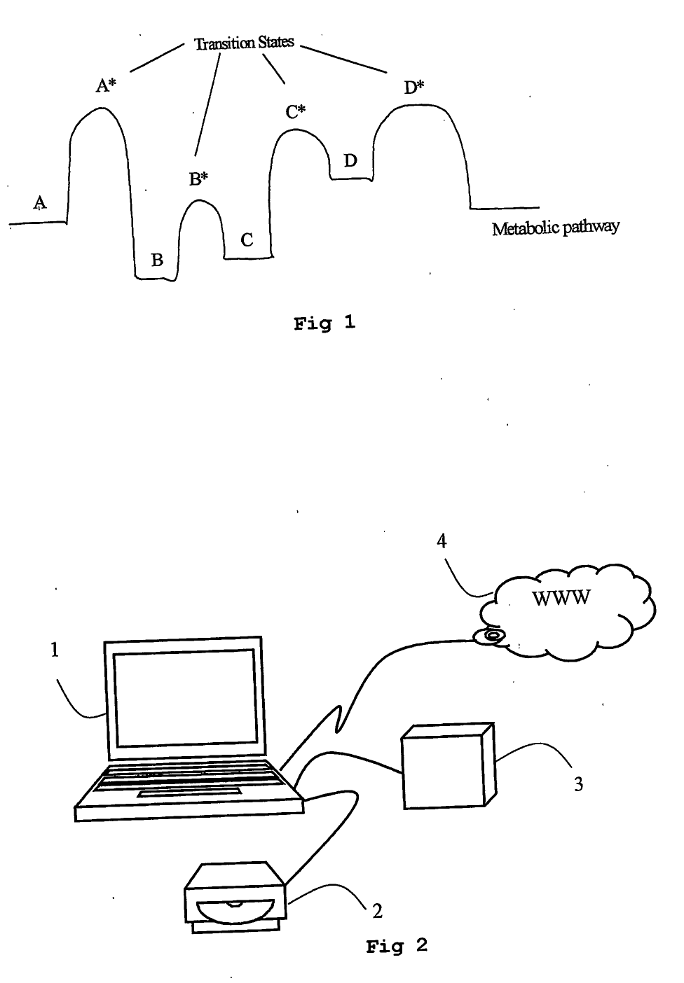

In FIG. 1 a schematic example of a metabolic pathway is illustrated, with reactions between different metabolites A, B, C, D, . . . and intermediate short-lived substances A*, B*, C*, D*, with higher internal energies. Each step in a metabolic pathway is characterized by the speed of that particular reaction, as well as the concentration of the reactants. In the present invention, the personal characteristics (=reaction parameters) of the most important pathways that are involved in the mechanisms of a certain drug need to measured. When these reaction parameters are determined, they can be fed into a computer-model of the involved metabolic pathways. Given knowledge about the relation between desired levels of reactant concentration and drug concentration, the computer model can be used to compute the biochemical effect of a certain concentration of the drug.

A biochemical profile common for a certain group of patients may be determined, in order to be able to apply the present invention on a group of patients and to establish general dosage limits for the drug in question.

Polypeptide Scaffold Technique

The measurement data needed for the personalized pathway model is obtained from a blood sample (or other sample) by a measurement device based on protein scaffolds. Such a synthetic protein can be constructed to bind to, and thereby measure concentrations of, substances e.g. in a metabolic pathway. A number of scaffold proteins can be constructed, e.g. on the order of 10 scaffolds, to measure enough reactants to give a reasonably precise pathway model.

Preferred protein scaffolds for use according to the present invention are folded, ligand modified helix-loop-helix polypeptide scaffolds that connect the biosensing events of recognition and reporting.

Such polypeptide scaffolds are shown in “Designed, Folded Polypeptide Scaffolds that Combine key Biosensing Events of Recognition and Reporting”, J. Org. Chem. 2002, 67, 3120-3123, by Karin Enander, Gunnar Dolphin, Linda Andersson, Bo Liedberg, Ingemar Lundström, Lars Baltzer, which describes a proof of principle demonstration based on the well characterized interaction between the enzyme human carbonic anhydrase II, HCAII, and its inhibitor 4-carboxybenzenesulfonamide. However, the variety of molecules that can be incorporated in the polypeptides, and the ease by which their relative positions can be varied, allow for the development of biosensing units for a wide range of receptor-ligand systems.

In the study referred to above, the peptides were designed to allow for a site-specific incorporation of a fluorescent probe, as well as of a ligand with high affinity for a target protein. Binding of the high affinity ligand to the target protein results in fluorescence intensity changes, which constitutes the proof of principle for functional helix-loop-helix based biosensor units. The use of an array of peptides modified with ligands of different affinities makes measurement of analyte concentrations possible, at levels of accuracy limited, in principle, only by the number of different ligand variants available and by the affinity range of those variants.

The possibility of incorporating a wide range of probes and ligands at different relative positions provides an attractive way of optimising the biosensing conditions, such as sensitivity and fluorescence response, for any target biomacromolecule. The structure of the peptide scaffold also plays an important role in sensor performance. A determination of analyte concentration is possible using an array of peptides modified with ligands of different affinities.

Apparatus

An apparatus for determining a drug dosage in accordance with an embodiment of the invention is illustrated in FIG. 2. The apparatus comprises main unit 1, which could e.g. be a conventional personal computer or the like, e.g. a special-purpose embedded computer. The main unit comprises an input interface for receiving data on at least one patient's biochemical profile, and data on at least one specific property of the drug. Further, the main unit comprises processing means having a simulation module for simulating the effect of a certain dosage based on the received data, and an evaluation module for determining, based on a simulation on at least one dosage, a drug dosage for the at least one patient in question.

The input interface for receiving data on the patient's biochemical profile could comprise a data-signal interface connectable to a reader 2 for a data carrier, such as a CD, a disc or a tape. Hereby, the biochemical profile could be measured beforehand and stored on a data carrier, and then be provided to the apparatus through the reader 2. The reader could also be used for receiving data on specific properties of the drug.

Alternatively or additionally, the interface may comprise a connection to a network 4, such as a LAN or a WLAN (e.g. the internet). Hereby, the biochemical profiles, data on specific properties of the drug and the like could be downloaded to the apparatus from providers connected to the network

Further, the interface may comprise a signal connection (for electrical or optical signals, or any other type of signal suitable for information transfer) to a measuring unit 3, such as a measuring unit for analyzing a blood sample from the patient. Hereby, the biochemical profiles could be determined based on the measurement results provided by the measuring unit 3.

Automatic Dosage Unit

The apparatus may be provided as a preferably self-contained and portable automatic dosage unit. In the practice of the present invention, each drug may come together with an automatic dosage unit and a sampling unit. The automatic dosage unit can, based on measurements from a blood sample from the patient, compute a recommended optimal dosage. The sampling unit can, based on a blood sample from the patient, using specialized protein scaffolds, bind to intermediate reaction products in reaction pathways. In this way the unit can measure personal parameters for certain reaction constants.

The dosage unit and the sampling unit may form a portable unit for specific use by the patient. Alternatively, they may form a more general instrumentation for use by the practising doctor.

The automatic dosage device may as an output deliver a quantity value representing a computed dosage to be used. Such a quantity value may be delivered by a visual interface, such as a text message on a display, an audio interface, or the like. However, the output from the automatic dosage device may alternatively be an actual dosage of the medication to be used. To this end, the device may comprise a delivery unit adapted to supply an amount of the pharmaceutical preparation corresponding to the determined dosage, subsequently to be given to the patient directly or to be mixed in nourishment to be given to the patient. Alternatively, the delivery unit may be controlled to provide the drug corresponding to the determined dosage directly to the patient, e.g. through injection.

Modelling and Simulation

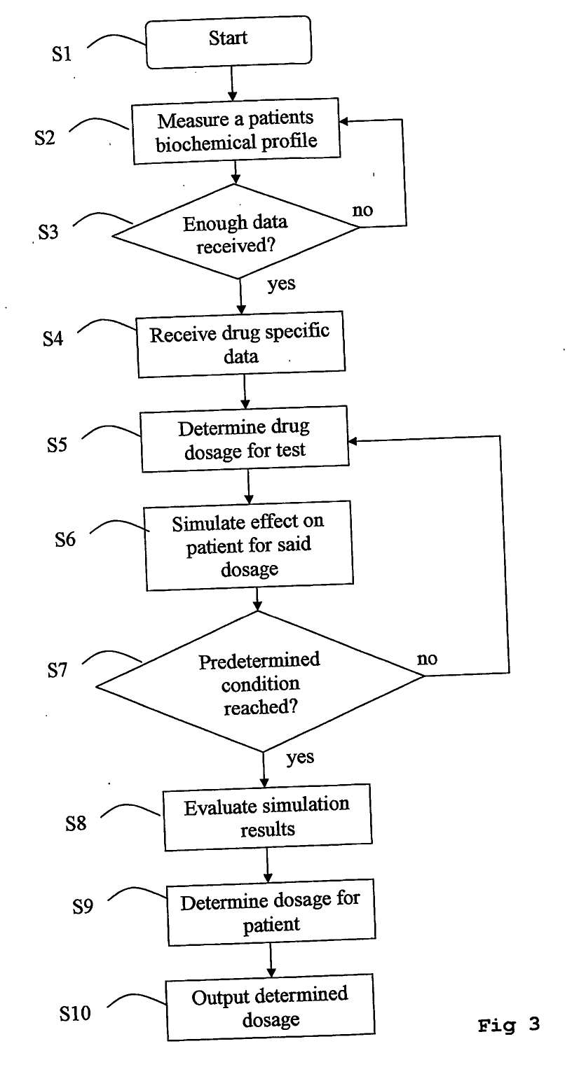

A method in accordance with an embodiment of the invention is illustrated schematically in the flow-chart of FIG. 3.

In a first step S2 a patient's biochemical profile is measured, as has already been discussed in more detail in the foregoing. The measurement may be conducted immediately prior to the simulation and evaluation by means of a measuring unit. Alternatively, the measurement may be conducted beforehand and stored on a data carrier. Thereafter, the data may be retrieved from a data carrier reader or a computer network when required.

After capturing the biochemical profile data, it is preferably evaluated in a subsequent step S3 whether enough information on the profile has been acquired for the task at hand or not. If the information is deemed insufficient, the process is returned to step S2 discussed above.

Before or after the reception of the biochemical profile of the patient, data is also received regarding the specific drug, step S4. How this is made and the type of data involved is discussed in more detail in the foregoing.

In step S5 a drug dosage to be used in the simulation is determined. This dosage could be chosen randomly, or based on previously known data on the drug, such as a recommended dosage for a certain type of patient. Further, the dosage may be chosen in accordance with a scheme of several different dosages to be tested.

A use of the drug dosage on the patient in question is thereafter simulated based on the received data regarding the drug and the biochemical profile of the patient. The simulation is preferably made by means of ordinary differential equations (ODEs), differential algebraic equations (DAEs), difference equations, partial differential equations (PDEs), functions, or combinations thereof, based on mathematical relationships which are per se previously known. However, certain relationships could have been obtained by fitting incomplete mathematical models to measurement data through system identification methods. Moreover, the simulation could be directly programmed in any programming language suited for computational applications. In the simulation-based approach the equations could be solved numerically by known methods, such as the Runge-Kutta solver, DASSL solver or the like. The simulation steps could be modelled and performed by means of a modelling language, and preferably in the modelling language Modelica. However, the present invention is not limited to the use of Modelica.

The adaptation of the equations in a Modelica model, and the solving of them in a Modelica based simulator, facilitates the flexibility, parameterisation, modularity and construction of the simulator. Further, it enables the use of model plug-ins for different drugs and patient categories.

After the simulation, it is determined in step S7 whether a predetermined condition has been reached, and if not, the process is repeated from step S5 and forward with a different dosage. The predetermined condition could e.g. be one or several of:

minimising possible side effects.

attaining a certain effect.

optimisation to a certain degree.

repetition for a certain number of cycles.

Normally, an interval of the dosage needs to be simulated, but there may be instances when one simulation, coupled to advanced calculation models, is sufficient.

When the simulation condition is met, the results of the simulations are evaluated in step S8, and based on said evaluation an efficient dosage for the patient is determined, step S9. The resulting dosage is preferably presented to the patient and/or the physician, e.g. by presentation on a display of the apparatus.

Specific embodiments of the invention have now been described. However, several alternatives are possible, as would be apparent for someone skilled in the art. For example, the biochemical profile may be measured for single individuals, or for a group of patients. Further, the biochemical profile may be approximately estimated instead of measured. Further, the method steps discussed above could be performed in a different order, unless otherwise is specifically expressed.

Still further, the implementation of the simulation and evaluation method could be accomplished in different ways, such as in especially dedicated hardware or in software, or in combinations thereof. Further, a single unit may perform the functions of several means recited in the claims or in the specification.

Such and other obvious modifications must be considered to be within the scope of the present invention, as it is defined by the appended claims. It should be noted that the above-mentioned embodiments illustrate rather than limit the invention, and that those skilled in the art will be able to design many alternative embodiments without departing from the scope of the appended claims.

1. An apparatus for determining a drug dosage comprising:
an input interface for receiving data on at least one patient's biochemical profile, and data on at least one specific property of the drug;
a processor having a simulation module for simulating the effect of a certain dosage based on the received data, and an evaluation module for determining, based on a simulation on at least one dosage, a drug dosage for the at least one patient in question.

2. The apparatus of claim 1, wherein the evaluation module is adapted to determine said drug dosage for the at least one patient in question based on several simulations on different dosages.

3. The apparatus of claim 1, wherein the biochemical profile data comprises at least one parameter related to the at least one patient's metabolic pathways.

4. The apparatus of claim 3, wherein the biochemical profile data is determined based on measurements performed on a blood sample from the at least one patient.

5. The apparatus of claim 4, wherein the measurement is made using a scaffold technique.

6. The apparatus of claim 3, wherein the at least one parameter related to a metabolic pathway is at least one of: the speed of the particular reaction to which the pathway pertains, the concentration of at least one reactant in the metabolic pathway, and the time required for decomposition of the drug.

7. The apparatus of claim 1, wherein the at least one specific property of the drug is at least one of: the distribution rate of the drug, the decomposition time of the active ingredients, and the decomposition time of possible by-products.

8. The apparatus of claim 1, wherein the simulation module is formed with an equation based modelling language.

9. The apparatus of claim 8, wherein the programming language is object-oriented.

10. The apparatus of claim 8, wherein the programming language further defines a multi-domain modelling capability.

11. The apparatus of claim 1, wherein the simulation module is adapted to perform a metabolic pathway simulation based on the received data.

12. The apparatus of claim 1, wherein the input interface further receives data specifying the most important metabolic pathways that are involved in the mechanisms of the drug in question, wherein the simulation module only performs simulations involving said specified pathways.

13. The apparatus of claim 1, wherein the evaluation module determines a drug dosage based on the relationship between desired levels of reactant concentration and drug concentration in the simulated process.

14. An automatic dosage device comprising an apparatus according to claim 1.

15. The automatic dosage device of claim 14, further comprising a measurement unit for determining a patient's biochemical profile, said measurement unit being connected to the input interface of the apparatus.

16. The automatic dosage device of claim 15, wherein the measurement unit determines the patient's biochemical profile based on a blood sample.

17. The automatic dosage device of claim 14, further comprising an output unit, such as a display, for communicating a recommended drug dosage for the patient in question to the user.

18. The automatic dosage device of claim 14, wherein the device is arranged within a self-contained portable unit.

19. A computer-implemented method for determining a drug dosage comprising:
receiving data regarding at least one patient's biochemical profile;
receiving data regarding at least one specific property of the drug;
simulating the effect of at least one dosage based on the received data; and
determining a drug dosage for the at least one patient in question based on the outcome of said simulation.

20. The method of claim 19, further comprising the step of repeating said simulation with at least one other dosage, wherein the step of determining a drug dosage for the at least one patient in question is based on the outcome of said simulations.

21. The method of claim 19, wherein the simulation step is repeated until a predetermined condition is met.

22. The method of claim 20, wherein the predetermined condition is one of: minimising possible side effects, attaining a certain effect, and optimisation to a certain degree.

23. The method of claim 17, wherein the biochemical profile data comprises at least one parameter related to the at least one patient's metabolic pathways.

24. The method of claim 17, wherein the biochemical profile data is determined based on at least one measurement performed on a blood sample from the at least one patient.

25. The method of claim 17, wherein the simulation performs a metabolic pathway simulation based on the received data.

26. The method of claim 17, wherein the drug dosage is determined based on the relation between desired levels of reactant concentration and drug concentration in the simulated process.

27. A computer program comprising computer program code for executing the method of claim 1.

28. A computer-readable medium, having the computer program according to claim 26 recorded thereon.
